(19) United States
(12) Patent Application Publication
(10) Pub. No.: US 2014/0252887 A1
(43) Pub. Date: Sep. 11, 2014

(54) SYNTHETIC JET ACTUATOR MOTOR EQUIPPED WITH MEANS FOR MAGNETIC FLUX PROFILING

(71) Applicant: Nuventix, Inc., Austin, TX (US)

(72) Inventor: Markus Schwickert, Scottsdale, AZ (US)

(73) Assignee: Nuventix, Inc., Austin, TX (US)

(21) Appl. No.: 14/197,205

(22) Filed: Mar. 4, 2014

Related U.S. Application Data
(60) Provisional application No. 61/772,064, filed on Mar. 4, 2013.
(60) Provisional application No. 61/774,974, filed on Mar. 8, 2013.

(51) Int. Cl. H02K 41/02

(52) U.S. Cl. CPC H02K 41/02
USPC 310/12.16

(57) ABSTRACT

A synthetic jet actuator is provided which includes a voice coil, a yoke consisting of a back iron (303) and pole piece, a plate (307), a first magnet (305) disposed on a first side of said plate, and a second magnet (309) disposed on a second side of said plate. The second magnet is disposed on said pole piece, and the first and second magnets and the plate cooperate to produce and direct magnetic flux which drives the voice coil.

### CROSS-REFERENCE TO RELATED APPLICATION

This application claims the benefit of U.S. provisional application No. 61/772,064, filed Mar. 4, 2013, having the same title, and the same inventor, and which is incorporated herein by reference in its entirety, and of U.S. provisional application No. 61/774,974, filed Mar. 8, 2013, entitled “Synthetic Jet Actuator Equipped with Means for Magnetic Flux Profiling”, having the same inventor, and which is incorporated herein by reference in its entirety.

### FIELD OF THE DISCLOSURE

The present disclosure relates generally to synthetic jet ejectors, and more particularly to motors for synthetic jet actuators that are equipped with a means for profiling magnetic flux.

### BACKGROUND OF THE DISCLOSURE

A variety of thermal management devices are known to the art, including conventional fan based systems, piezoelectric systems, and synthetic jet ejectors. The latter type of system has emerged as a highly efficient and versatile thermal management solution, especially in applications where thermal management is required at the local level.

Various examples of synthetic jet ejectors are known to the art. Earlier examples are described in U.S. Pat. No. 5,758,823 (Glezer et al.), entitled “Synthetic Jet Actuator and Applications Thereof”; U.S. Pat. No. 5,894,990 (Glezer et al.), entitled “Synthetic Jet Actuator and Applications Thereof”; U.S. Pat. No. 5,988,522 (Glezer et al.), entitled Synthetic Jet Actuators for Modifying the Direction of Fluid Flows”; U.S. Pat. No. 6,056,204 (Glezer et al.), entitled “Synthetic Jet Actuators for Mixing Applications”; U.S. Pat. No. 6,123,145 (Glezer et al.), entitled Synthetic Jet Actuators for Cooling Heated Bodies and Environments”; and U.S. Pat. No. 6,588,497 (Glezer et al.), entitled “System and Method for Thermal Management by Synthetic Jet Ejector Channel Cooling Techniques”.

Further advances have been made in the art of synthetic jet ejectors, both with respect to synthetic jet ejector technology in general and with respect to the applications of this technology. Some examples of these advances are described in U.S. 20100263838 (Mahalingam et al.), entitled “Synthetic Jet Ejector for Augmentation of Pumped Liquid Loop Cooling and Enhancement of Pool and Flow Boiling”; U.S. 20100039012 (Grimm), entitled “Advanced Synjet Cooler Design For LED Light Modules”; U.S. 20100033071 (Heffington et al.), entitled “Thermal management of LED Illumination Devices”; U.S. 20090141065 (Darbin et al.), entitled “Method and Apparatus for Controlling Diaphragm Displacement in Synthetic Jet Actuators”; U.S. 20090109625 (Booth et al.), entitled Light Fixture with Multiple LEDs and Synthetic Jet Thermal Management System“; U.S. 20090084866 (Grimm et al.), entitled Vibration Balanced Synthetic Jet Ejector”; U.S. 20080295997 (Heffington et al.), entitled Synthetic Jet Ejector with Viewing Window and Temporal Aliasing”; U.S. 20080219007 (Heffington et al.), entitled “Thermal Management System for LED Array”; U.S. 20080151541 (Heffington et al.), entitled “Thermal Management System for LED Array”; U.S. 20080043061 (Glezer et al.), entitled “Methods for Reducing the Non-Linear Behavior of Actuators Used for Synthetic Jets”; U.S. 20080009187 (Grimm et al.), entitled “Moldable Housing design for Synthetic Jet Ejector”; U.S. 20080006393 (Grimm), entitled Vibration Isolation System for Synthetic Jet Devices”; U.S. 20070272393 (Reichenbach), entitled “Electronics Package for Synthetic Jet Ejectors”; U.S. 20070141453 (Mahalingam et al.), entitled “Thermal Management of Batteries using Synthetic Jets”; U.S. 20070096118 (Mahalingam et al.), entitled “Synthetic Jet Cooling System for LED Module”; U.S. 20070081027 (Beltran et al.), entitled “Acoustic Resonator for Synthetic Jet Generation for Thermal Management”; U.S. 20070023169 (Mahalingam et al.), entitled “Synthetic Jet Ejector for Augmentation of Pumped Liquid Loop Cooling and Enhancement of Pool and Flow Boiling”; U.S. 20070119573 (Mahalingam et al.), entitled “Synthetic Jet Ejector for the Thermal Management of PCI Cards”; U.S. 20070119575 (Glezer et al.), entitled “Synthetic Jet Heat Pipe Thermal Management System”; U.S. 20070127210 (Mahalingam et al.), entitled “Thermal Management System for Distributed Heat Sources”; U.S. 20070141453 (Mahalingam et al.), entitled “Thermal Management of Batteries using Synthetic Jets”; U.S. Pat. No. 7,252,140 (Glezer et al.), entitled “Apparatus and Method for Enhanced Heat Transfer”; U.S. Pat. No. 7,606,029 (Mahalingam et al.), entitled “Thermal Management System for Distributed Heat Sources”; U.S. Pat. No. 7,607,470 (Glezer et al.), entitled “Synthetic Jet Heat Pipe Thermal Management System”; U.S. Pat. No. 7,760,499 (Darbin et al.), entitled “Thermal Management System for Card Cages”; U.S. Pat. No. 7,768,779 (Heffington et al.), entitled “Synthetic Jet Ejector with Viewing Window and Temporal Aliasing”; U.S. Pat. No. 7,784,972 (Heffington et al.), entitled “Thermal Management System for LED Array”; and U.S. Pat. No. 7,819,556 (Heffington et al.), entitled “Thermal Management System for LED Array”.

### BRIEF DESCRIPTION OF THE DRAWINGS

FIGS. 1A-1C are illustrations depicting the manner in which a synthetic jet actuator operates.

FIG. 2 is an illustration of a conventional motor for a synthetic jet ejector.

FIG. 3 is an illustration of a motor for a synthetic jet ejector in accordance with the teachings herein.

FIG. 4 depicts the results of an FEMM simulation for a standard magnet arrangement, a 2/3 magnet volume, an NS-SN arrangement with a back iron, and an NS-SN arrangement with an iron ring.

FIG. 5 is a graph of the normal B-field component for each of the arrangements of FIG. 4.

FIG. 6 is an illustration of an embodiment of a motor for a synthetic jet actuator in accordance with the teachings herein.

FIG. 7 is an illustration of a motor for a synthetic jet ejector in accordance with the teachings herein.

### SUMMARY OF THE DISCLOSURE

In one aspect, a synthetic jet actuator is provided which comprises (a) a voice coil; (b) a yoke consisting of a back iron and pole piece; (c) a plate; (d) a first magnet disposed on a first side of said plate; and (e) a second magnet disposed on a second side of said plate. The second magnet is disposed on said pole piece, and the first and second magnets and the plate cooperate to produce and direct magnetic flux which drives the voice coil.

In another aspect, a synthetic jet actuator is provided which comprises (a) a voice coil; (b) a plate; (c) a first magnet disposed on a first side of said plate; (d) a second magnet disposed on a second side of said plate; and (e) a ring. The first and second magnets and the plate cooperate to produce and direct magnetic flux which drives the voice coil.

In a further aspect, a synthetic jet actuator is provided which comprises (a) a voice coil; (b) a yoke consisting of a back iron and pole piece; (c) a plate; and (d) at least first and second magnets disposed radially about said pole piece, and wherein the first and second magnets and the plate cooperate to produce and direct magnetic flux which drives the voice coil.

### DETAILED DESCRIPTION

Despite the many advances in synthetic jet ejector technology, a need for further advances in this technology still exists. For example, conventional synthetic jet actuators and the motors they utilize typically feature a back iron that acts as a yoke, in combination with a magnet and top plate, to produce and direct the magnetic flux required to move the motor coil in the actuator. However, it has been found that this configuration can produce magnetic flux profiles that are sufficiently asymmetric so as to give rise to significant harmonic distortions.

It has now been found that the foregoing infirmity may be overcome with the devices and methodologies disclosed herein. In a preferred embodiment, synthetic jet ejectors are provided which are equipped with two opposing magnets sandwiched around an iron plate. Such a configuration allows the magnetic field to be directed radially outwards from the structure and to avoid shorting of the field lines, and allows a very symmetric, strong field to be obtained.

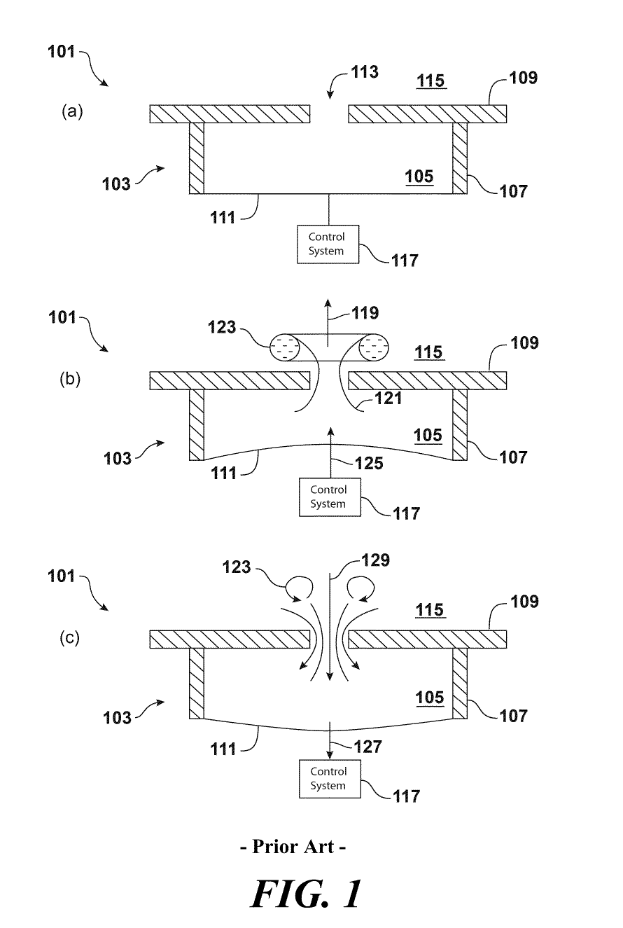

Prior to further describing the systems and methodologies disclosed herein, a brief overview of synthetic jet actuators may be helpful. The operation of a synthetic jet ejector and the formation of a synthetic jet are illustrated in FIGS. 1a-1c.

With reference to FIG. 1a, the structure of a synthetic jet ejector may be appreciated. The synthetic jet ejector 101 depicted therein comprises a housing 103 which defines and encloses an internal chamber 105. The housing 103 and chamber 105 may take virtually any geometric configuration, but for purposes of discussion and understanding, the housing 103 is shown in cross-section in FIG. 1a to have a rigid side wall 107, a rigid front wall 109, and a rear diaphragm 111 that is flexible to an extent to permit movement of the diaphragm 111 inwardly and outwardly relative to the chamber 105. The front wall 109 has an orifice 113 therein which may be of various geometric shapes. The orifice 113 diametrically opposes the rear diaphragm 111 and fluidically connects the internal chamber 105 to an external environment having ambient fluid 115.

The movement of the flexible diaphragm 111 may be controlled by any suitable control system 117. For example, the diaphragm may be moved by a voice coil actuator. The diaphragm 111 may also be equipped with a metal layer, and a metal electrode may be disposed adjacent to, but spaced from, the metal layer so that the diaphragm 111 can be moved via an electrical bias imposed between the electrode and the metal layer. Moreover, the generation of the electrical bias can be controlled by any suitable device, for example but not limited to, a computer, logic processor, or signal generator. The control system 117 can cause the diaphragm 111 to move periodically or to modulate in time-harmonic motion, thus forcing fluid in and out of the orifice 113.

Alternatively, a piezoelectric actuator could be attached to the diaphragm 111. The control system would, in that case, cause the piezoelectric actuator to vibrate and thereby move the diaphragm 111 in time-harmonic motion. The method of causing the diaphragm 111 to modulate is not particularly limited to any particular means or structure.

The operation of the synthetic jet ejector 101 will now be described with reference to FIGS. 1b-FIG. 1c. FIG. 1b depicts the synthetic jet ejector 101 as the diaphragm 111 is controlled to move inward into the chamber 105, as depicted by arrow 125. The chamber 105 has its volume decreased and fluid is ejected through the orifice 113. As the fluid exits the chamber 105 through the orifice 113, the flow separates at the (preferably sharp) edges of the orifice 113 and creates vortex sheets 121. These vortex sheets 121 roll into vortices 123 and begin to move away from the edges of the orifice 109 in the direction indicated by arrow 119.

FIG. 1c depicts the synthetic jet ejector 101 as the diaphragm 111 is controlled to move outward with respect to the chamber 105, as depicted by arrow 127. The chamber 105 has its volume increased and ambient fluid 115 rushes into the chamber 105 as depicted by the set of arrows 129. The diaphragm 111 is controlled by the control system 117 so that, when the diaphragm 111 moves away from the chamber 105, the vortices 123 are already removed from the edges of the orifice 113 and thus are not affected by the ambient fluid 115 being drawn into the chamber 105. Meanwhile, a jet of ambient fluid 115 is synthesized by the vortices 123, thus creating strong entrainment of ambient fluid drawn from large distances away from the orifice 109.

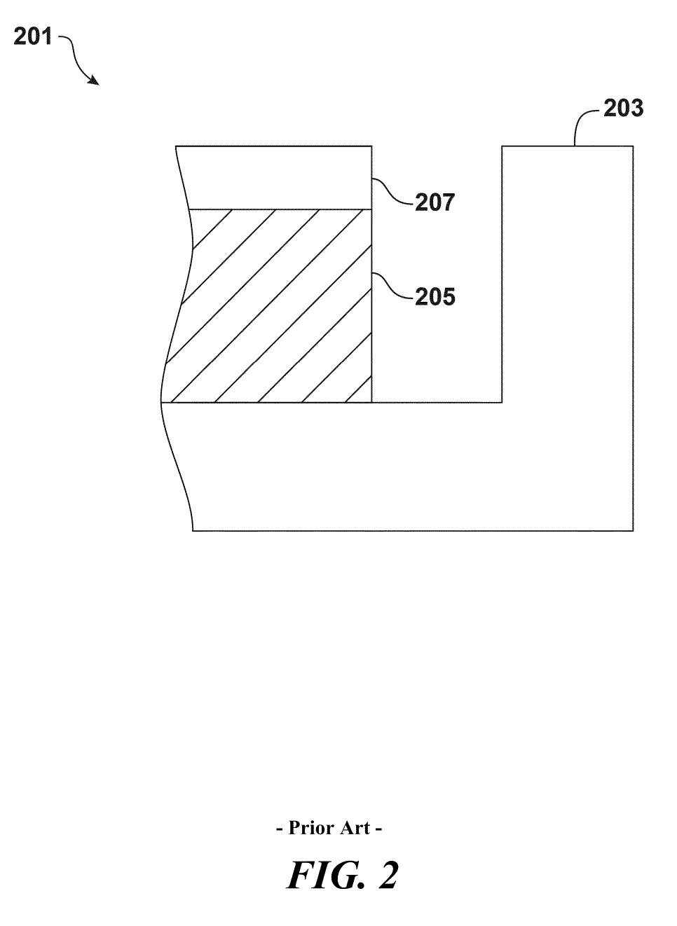

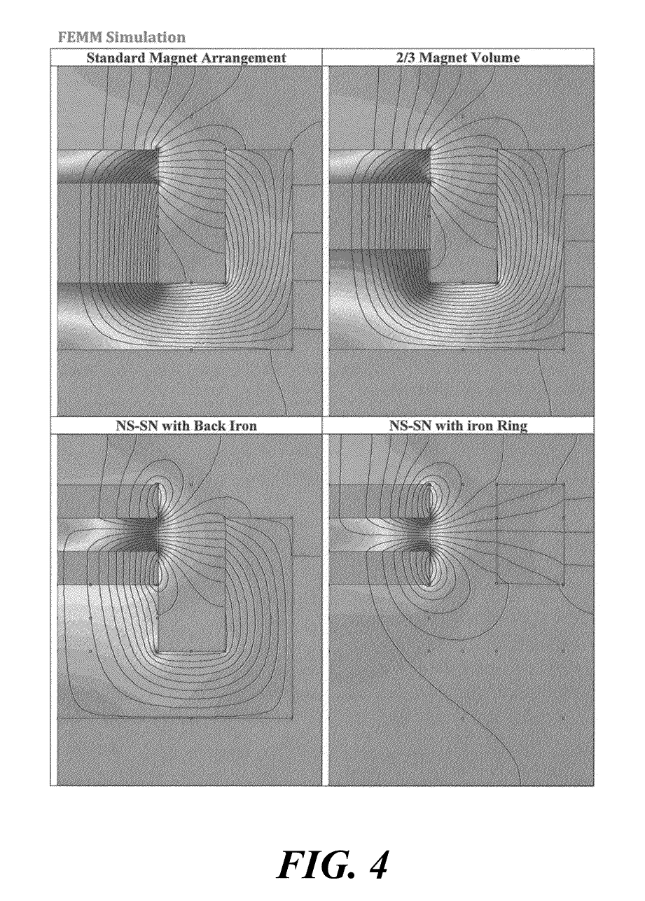

FIG. 2 depicts a portion of a conventional motor structure (in air) for the voice coil actuator of a synthetic jet ejector. The details of the remainder of the voice coil actuator have been omitted for simplicity of illustration but may be found, for example, in U.S. Pat. No. 7,768,779 (Heffington et al.), which is incorporated herein by reference in its entirety (see, e.g., FIGS. 28-31 thereof), or in U.S. Pat. No. 8,066,410 (Boothe et al.), which is also incorporated herein by reference in its entirety (see, e.g., FIGS. 4-6 and 12-14 thereof).

The motor structure 201 depicted in FIG. 2 comprises a back iron 203 which acts as a yoke, a magnet 205 and a top plate 207. In the particular structure depicted, the back iron 203 and top plate 207 consist of pure iron, while the magnet 205 consists of a Neodymium Iron Boron (NdFeB) magnet with a maximum energy product (BHmax) rating of 40 MgOe. These elements act together to produce and direct the magnetic flux needed to move the motor coil in the voice coil actuator.

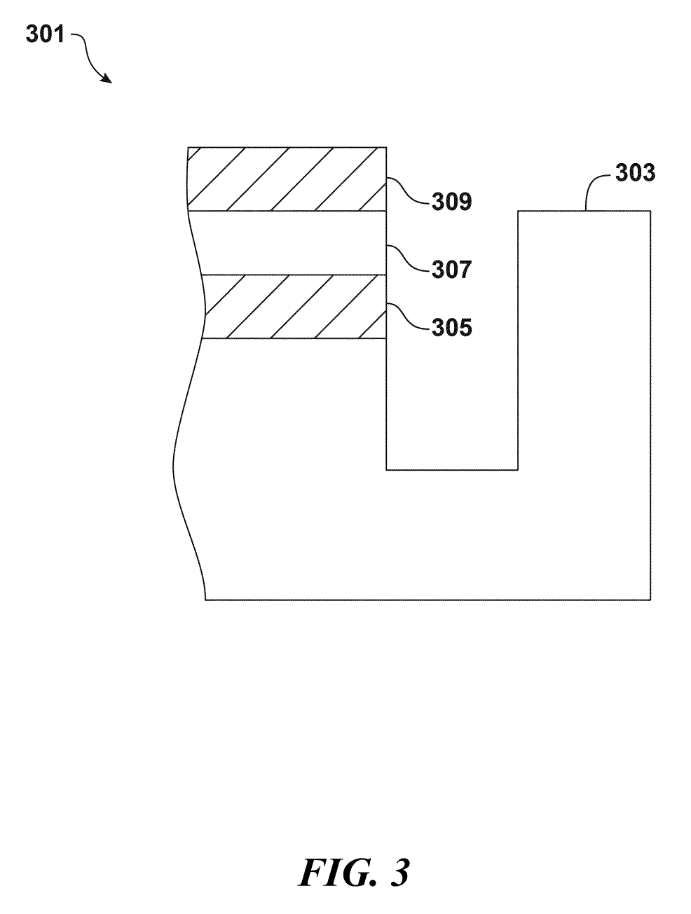

FIG. 3 depicts a portion of a particular, non-limiting embodiment of a motor structure (in air) for a synthetic jet actuator in accordance with the teachings herein. The motor structure 301 depicted therein comprises a back iron 303 which acts as a yoke, and first 305 and second 309 magnets which are separated by an intervening plate 307. In a preferred embodiment of the particular structure depicted, the back iron 303 and intervening plate 307 consist of pure iron, while the first 305 and second 309 magnets are Neodymium Iron Boron (NdFeB) magnets with a maximum energy product (BHmax) rating of 40 MgOe. The first 305 and second 309 magnets are arranged with opposing polarities. These elements act together to produce and direct the magnetic flux needed to move the motor coil in the voice coil actuator.

The motor structure 301 of FIG. 3 differs from the motor structure 201 of FIG. 2 in that the single larger magnet 205 of FIG. 2 has been replaced with two smaller magnets 305 and 309 of lesser total volume. Also, the shape of the back iron 303 in FIG. 3 is more U-shaped than the back iron 203 of FIG. 2.

The symmetry of the magnetic field produced by the motor of a synthetic jet actuator is important to reduce harmonic distortions. The embodiment of FIG. 3 provides a means for generating more symmetric and focused magnetic fields with radial symmetry and with high radial-normal field strength, while also reducing the total magnet volume (a cost savings). In particular, by using two magnets 305 and 309 sandwiched around an iron plate 307, the magnetic field may be directed radially outwards from the structure 301 and the shorting of field lines may be avoided. If a back-iron structure is replaced with an iron ring (see FIG. 4), then a very symmetric and strong field may be achieved.

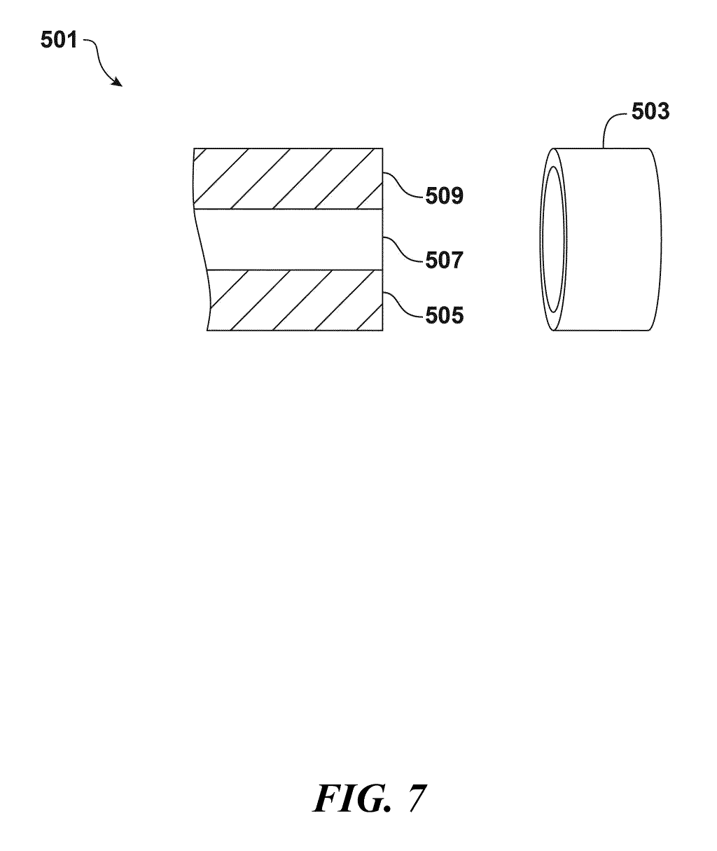

FIG. 7 illustrates another particular, non-limiting embodiment of a motor structure (in air) for a synthetic jet actuator in accordance with the teachings herein. The motor structure 501 depicted therein lacks a back iron altogether, but is equipped instead with a ring 503, as well as first 505 and second 509 magnets which are separated by an intervening plate 507. In a preferred embodiment of the particular structure depicted, the ring 503 and intervening plate 507 consist of pure iron, while the first 505 and second 509 magnets are Neodymium Iron Boron (NdFeB) magnets with a maximum energy product (BHmax) rating of 40 MgOe. The first 505 and second 509 magnets are arranged with opposing polarities. These elements act together to produce and direct the magnetic flux needed to move the motor coil in the voice coil actuator.

FIG. 4 illustrates the results of a finite element simulation with four different motor structures and calculations. The first of these (upper left) motor structures is for a conventional structure of the type depicted in FIG. 2. The second (upper right) of these motor structures is the same as the first, except that the magnet volume has been reduced to ⅔ for better comparison with the following NS-SN structures. The third of these motor structures is of the type depicted in FIG. 3 (that is, an NS-SN structure with a back iron). The fourth of these motor structures is of the type depicted in FIG. 3 (that is, it has an NS-SN structure without a back iron, but with an iron ring).

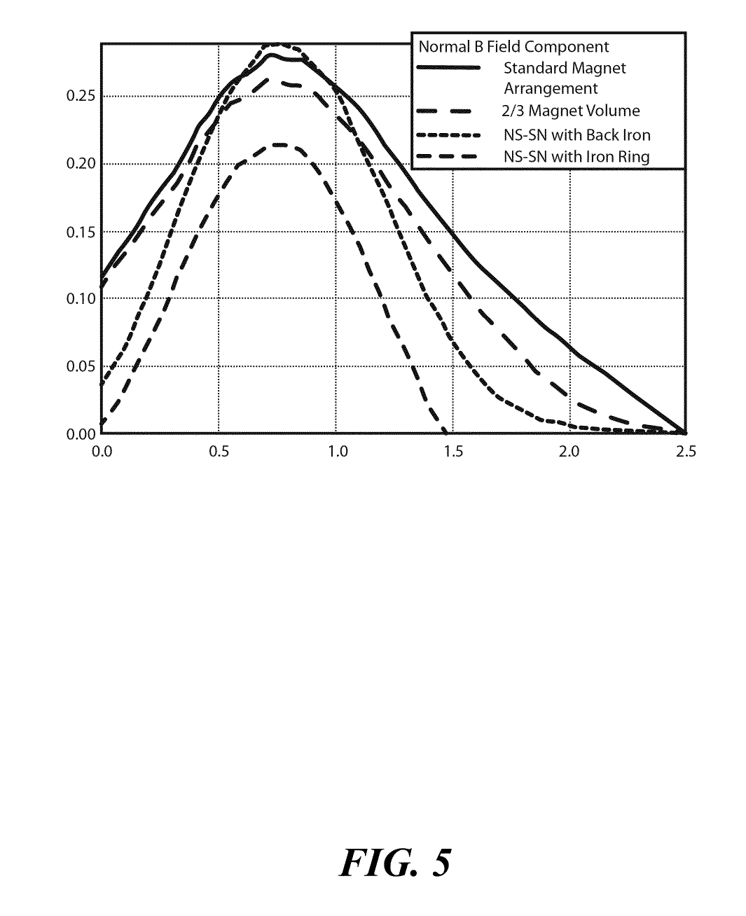

The normal B-field component for the four motor structures of FIG. 4 is shown in FIG. 5. As seen therein, the motor structure of FIG. 3 provides an improvement in the symmetry of the magnetic flux profile (B field component) of the motor structure as compared to either the standard motor structure of FIG. 2, or the ⅔ magnet volume variant of that structure. The motor structure of FIG. 7 provides a further improvement in magnetic flux profile.

Variations modifications to and extensions of the foregoing systems are possible. For example, in some embodiments, a transducer may be provided that has two motor structures and two voice coils driving one diaphragm to create a driver with a symmetric flux field. In other embodiments, a transducer may be provided that has two non-symmetric flux field motor structures combined to produce one drive unit that has a symmetric flux field. In still other embodiments, a transducer may be provided that has two motor structures and two voice coils driving one diaphragm, and that utilizes a shorted ring of non-ferrous material within the magnetic circuit that may reduce harmonic distortion.

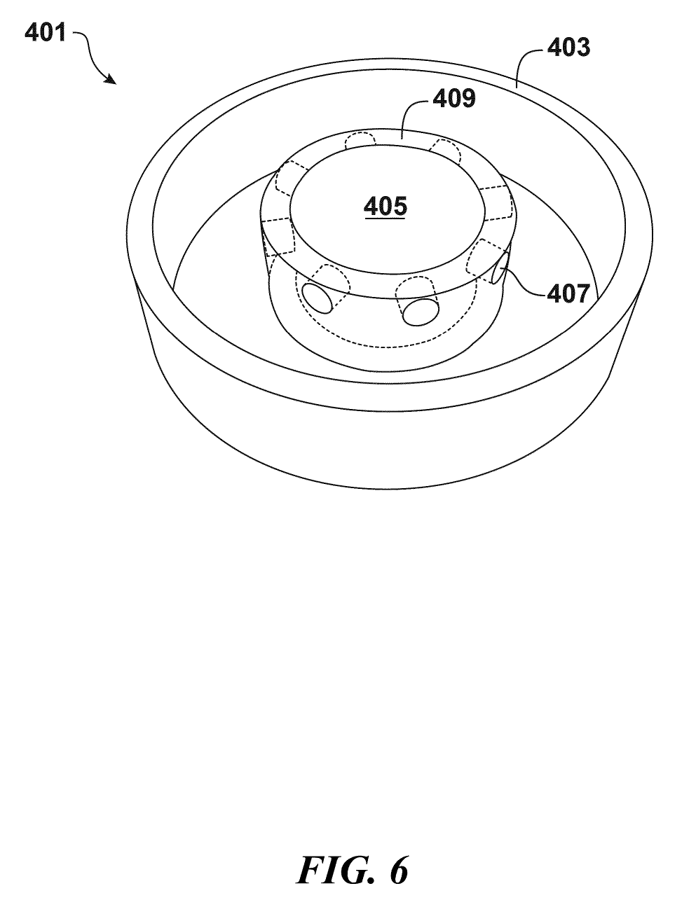

FIG. 6 is an illustration of another particular, non-limiting embodiment of a motor structure for a synthetic jet actuator in accordance with the teachings herein which may be utilized to create a symmetric, strong magnetic field. The motor structure 401 depicted therein comprises a back iron 403, a yoke 405, and a plurality of magnets 407 disposed within a plastic ring 409 and backed up against the surface of the yoke 405 so as to close the flux lines. These elements cooperate to produce and direct the magnetic flux required to move the motor coil of the synthetic jet actuator. In the particular embodiment depicted, magnets 407 are placed inside the yoke 405 in such a way that a radial magnetic field is created.

The magnets 407 may have any shape that fits within the motor structure, so long as the magnets create the desired magnetic field properties. Similarly, the number of magnets 407 utilized may vary but is preferably two or more, preferably 2 to 14, more preferably 6 to 10, and most preferably 8, with the particular number for a given implementation or application being selected to ensure that field strength and uniformity matches the requirements. Likewise, the magnets 407 are preferably evenly spaced, and are preferably all the same size.

In some embodiments, the magnets may be placed inside the yoke, or may be placed into or onto the back iron surfaces without being fully enclosed. Thus, for example, the magnets may be placed into preformed recesses, flat areas or drilled holes.

The magnets may be placed on the inner yoke surface or on the inside of the outer yoke surface. In some cases, this may provide cost reduction (due to less magnet material required), easier assembly (since pre-magnetized magnets may be utilized and adhesives won't be necessary) better control over field/flux shape and strength, and adaptability of the design to vary field strength by adjusting the number of magnets.

It will be appreciated that the embodiment of FIG. 6 may have other advantages as well. For example, this structure allows for more design freedom in the shape of the back iron. For example, the back iron may be configured with a central hole (for example, to provide air flow, cooling, structural aid, to serve as a guide, or for other purposes), so long as the required magnetic properties are provided.

Various types of magnets may be utilized in the devices and methodologies described herein. However, the use of Neodymium Iron Boron (NdFeB) magnets is preferred. Preferably, the NdFeB magnets utilized have BHmax ratings within the range of 27 MGOe to 52 MGOe and a maximum operating temperature rating which ranges from +60+80° C. to +220/+230° C. (that is, from Ny up to NyVH/NyAH, where y is the Maximum Energy Product in MGOe).

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

1. A synthetic jet actuator, comprising:
a voice coil;
a yoke consisting of a back iron and pole piece;
a plate;
a first magnet disposed on a first side of said plate and a second magnet disposed on a second side of said plate;
wherein said second magnet is disposed on said pole piece, and wherein the first and second magnets and the plate cooperate to produce and direct magnetic flux which drives the voice coil.

2. The synthetic jet actuator of claim 1, wherein said back iron and pole piece form an integral unit.

3. The synthetic jet actuator of claim 1, wherein said back iron is annular, and wherein said pole piece is centrally disposed in the annulus of said back iron.

4. The synthetic jet actuator of claim 3, wherein said pole piece is cylindrical.

5. The synthetic jet actuator of claim 4, wherein said back iron has a circumferential wall, and wherein the height of the circumferential wall is equal to the height of said cylinder.

6. The synthetic jet actuator of claim 1, wherein said first and second magnets have first and second poles, and wherein said first and second magnets are arranged so that their first poles are directed toward each other, and their second poles are directed away from each other.

7. The synthetic jet actuator of claim 6, wherein the first pole is south, and the second pole is north.

8. A synthetic jet actuator, comprising:
a voice coil;
a plate;
a first magnet disposed on a first side of said plate and a second magnet disposed on a second side of said plate; and
a ring;
wherein the first and second magnets and the plate cooperate to produce and direct magnetic flux which drives the voice coil.

9. The synthetic jet actuator of claim 8, wherein said plate and said first and second magnets are disposed within the volume of said ring.

10. The synthetic jet actuator of claim 8, wherein said first and second magnets have first and second poles, and wherein said first and second magnets are arranged so that their first poles are directed toward each other, and their second poles are directed away from each other.

11. The synthetic jet actuator of claim 10, wherein the first pole is south, and the second pole is north.

12. A synthetic jet actuator, comprising:
a voice coil;
a yoke consisting of a back iron and pole piece;
a plate; and
at least first and second magnets disposed radially about said pole piece, and wherein the first and second magnets and the plate cooperate to produce and direct magnetic flux which drives the voice coil.

13. The synthetic jet actuator of claim 12, wherein said back iron and pole piece form an integral unit.

14. The synthetic jet actuator of claim 12, wherein said back iron is annular, and wherein said pole piece is centrally disposed in the annulus of said back iron.

15. The synthetic jet actuator of claim 14, wherein said pole piece is cylindrical.

16. The synthetic jet actuator of claim 15, wherein said back iron has a circumferential wall, and wherein the height of the circumferential wall is equal to the height of said cylinder.

17. The synthetic jet actuator of claim 12, wherein said pole piece is cylindrical, and wherein said first and second magnets are disposed on the radial surface of said cylinder.

18. The synthetic jet actuator of claim 12, wherein said pole piece is cylindrical, wherein the radial surface of said pole piece is covered in a plastic ring, and wherein said first and second magnets are disposed in said plastic ring.
